(19) United States
(12) Patent Application Publication
(10) Pub. No.: US 2026/0181687 A1
(43) Pub. Date: Jun. 25, 2026

(54) METHODS, APPARATUSES AND SYSTEMS FOR CONTENTION BASED UPLINK MESSAGE TRANSMISSION EARLY TERMINATION

(71) Applicant: InterDigital Patent Holdings, Inc., Wilmington, DE (US)

(72) Inventors: Brian Martin, Farnham (GB); Umer Salim, Vallauris (FR); Dylan Watts, Montreal (CA); Keiichi Kubota, Setagaya-Ku (JP)

(21) Appl. No.: 18/989,480

(22) Filed: Dec. 20, 2024

(51) Int. Cl. H04W 74/08; H04W 74/00

(52) U.S. Cl. CPC H04W 74/08; H04W 74/004

(57) ABSTRACT

In an embodiment, a method, implemented in a WTRU, comprises: receiving a first message comprising first information indicating an uplink resources configuration for early data transmission procedure, the uplink resources configuration including early data transmission uplink resources, and a resources configuration for allocation of slots for data packet replica transmission; selecting a set of uplink resources of the uplink resources for uplink transmission, including a set of slots for uplink transmission replicas; transmitting using the selected set of uplink resources an uplink message comprising second information indicating an expectation for a RRC response message from the network; monitoring for a downlink message from the network; receiving the downlink message comprising an indication on an early termination of the uplink message transmission; determining if the early data transmission procedure is terminated; and on condition that the early data transmission procedure is determined as not terminated, monitoring for the RRC response message.

### FIELD OF THE INVENTION

The present disclosure is generally directed to methods, architecture apparatuses and systems for contention based uplink message transmission early termination. More particularly, the present disclosure relates to methods for early termination of uplink transmission with indication of whether to terminate uplink only or also downlink.

### BACKGROUND

Narrow band Internet of Thing (NB-IoT) non terrestrial network (NTN) is already being deployed. Current NB IoT NTN uplink (UL) system capacity may be severely limited by the corresponding system downlink (DL) capacity, due to the larger signaling overhead in the downlink (up to ˜53%), and the tight coupling between UL and DL signaling. This also may impact predominantly UL driven traffic, such as Mobile Originated (MO) transmissions, which may be the primary target of massive IoT and initial emergency messaging use cases supported by IoT NTN. Therefore, in order to unlock the additional UL capacity potential, there is a need to identify methods to decouple the UL from the DL as much as possible.

### SUMMARY

In an embodiment, a method, implemented in a wireless transmit/receive unit (WTRU), may comprise a step of receiving, from a network, a first message comprising first information indicating a shared uplink resources configuration for early data transmission procedure, the shared uplink resources configuration including early data transmission uplink resources, and a resources configuration for allocation of slots for data packet replica transmission. The method may comprise a step of selecting a set of uplink resources of the shared uplink resources for uplink transmission, including a set of slots for uplink transmission replicas. The method may comprise a step of transmitting using the selected set of uplink resources, to the network, an uplink message comprising second information indicating an expectation for a radio resource control (RRC) response message from the network. Upon transmission of one or more replicas of the uplink message on the selected set of uplink resources, the method may comprise a step of monitoring for a downlink message from the network. The method may comprise a step of receiving, from the network, the downlink message comprising an indication on an early termination of the uplink message transmission. The method may comprise a step of determining, based on the indication on an early termination of the uplink message transmission, if the early data transmission procedure is terminated; and on condition that the early data transmission procedure is determined as not terminated, the method may comprise a step of monitoring for the RRC response message. Following the receiving of the indication on the early termination of the uplink message transmission, the method may comprise a step of stopping uplink message transmissions.

On condition that the early data procedure is determined as terminated, the method may comprise a step of stopping monitoring for the downlink message from the network, and remaining in RRC_idle mode. The determining that the early data transmission procedure is not terminated may be based on the indication including any of a radio network temporary identifier (RNTI) to monitor for the downlink message to receive the RRC response message, a PDSCH resource on which to receive the RRC response, a delay before monitoring the downlink message, and a counter value after which the WTRU release RRC connection. The downlink message may be a physical downlink control channel (PDCCH) transmission from the network. The uplink message may be a contention based Msg3 message transmitted on a physical uplink shared channel (PUSCH). The resources configuration for allocation of slots for data packet replica transmission may include a diversity slotted ALOHA (DSA) or contention resolution DSA (CRDSA) resources configuration for replica transmission. The shared uplink resources configuration may further comprise a coding configuration for the uplink transmission, and wherein the uplink message and the one or more replicas of the uplink message are transmitted using the coding configuration. The indication on an early termination of the uplink message transmission may be a MAC CE field in a contention resolution MAC CE. The indication on an early termination of the uplink message transmission may be included in a downlink control information scheduling a MAC CE in a contention resolution MAC CE.

In an embodiment, a wireless transmit/receive unit (WTRU) comprising a processor, a transceiver and a memory, may be configured to receive, from a network, a first message comprising first information indicating a shared uplink resources configuration for early data transmission procedure, the shared uplink resources configuration including early data transmission uplink resources, and a resources configuration for allocation of slots for data packet replica transmission. The WTRU may be configured to select a set of uplink resources of the shared uplink resources for uplink transmission including a set of slots for uplink transmission replicas. The WTRU may be configured to transmit using the selected set of uplink resources, to the network, an uplink message comprising second information indicating an expectation for a radio resource control (RRC) response message from the network. The WTRU may be configured to monitor for a downlink message from the network, upon transmission of one or more replicas of the uplink message on the selected set of uplink resources. The WTRU may be configured to receive, from the network, the downlink message comprises an indication on an early termination of the uplink message transmission. The WTRU may be configured to determine, based on the indication on an early termination of the uplink message transmission, if the early data transmission procedure is terminated; and to monitor for the RRC response message, on condition that the early data transmission procedure is determined as not terminated.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example of a block diagram illustrating different interfaces in a non-terrestrial network, according to an embodiment;

FIG. 3 is an example of a block diagram illustrating an example of packet duplication using contention resolution diversity slotted additive links on-line Hawaii area (ALOHA) (CRDSA);

FIG. 4 is an example of a signaling diagram illustrating an example of a method to terminate uplink Msg3 transmission and determine whether to terminate an early data transmission (EDT) procedure early or monitor PDCCH for RRC termination and downlink application layer response according to an embodiment; and

FIG. 5 is an example of a flow chart illustrating an example of a method to terminate uplink message transmission and determine whether to terminate an EDT procedure early or monitor PDCCH for RRC termination according to another embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A sign, symbol, or mark of forward slash ‘/’ is to be interpreted as ‘and/or’ unless particularly mentioned otherwise, where for example, ‘A/B’ may imply ‘A and/or B’.

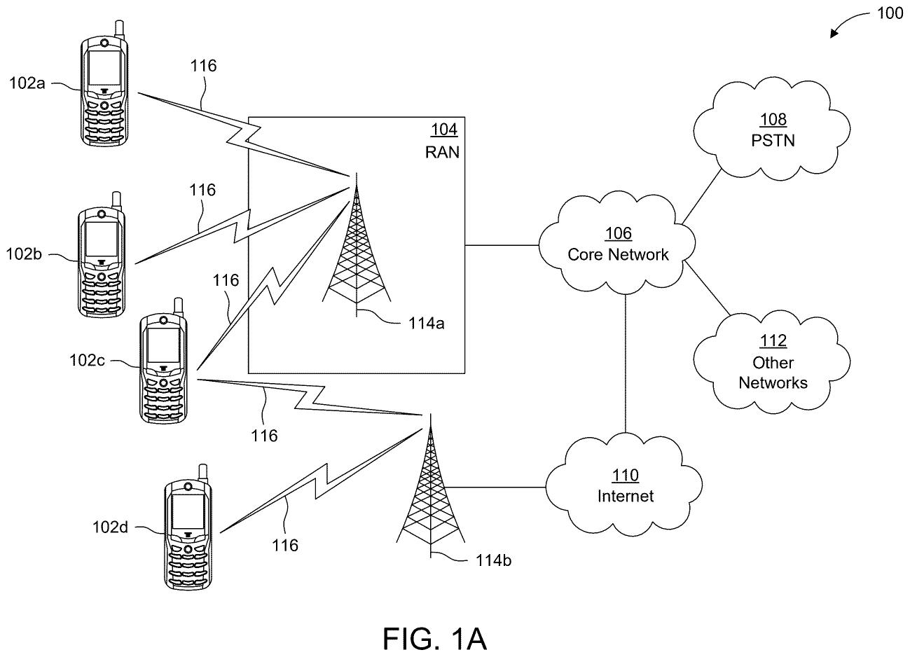

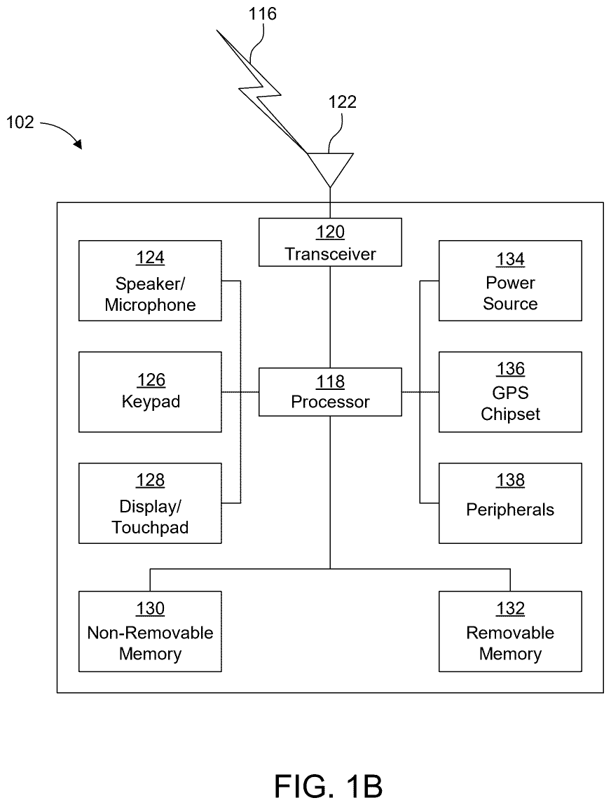

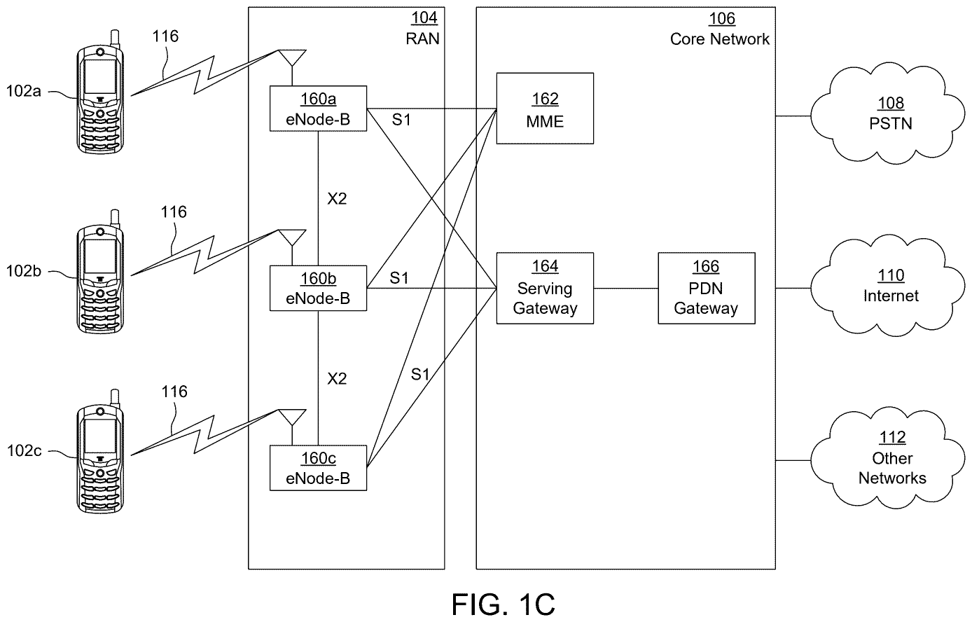

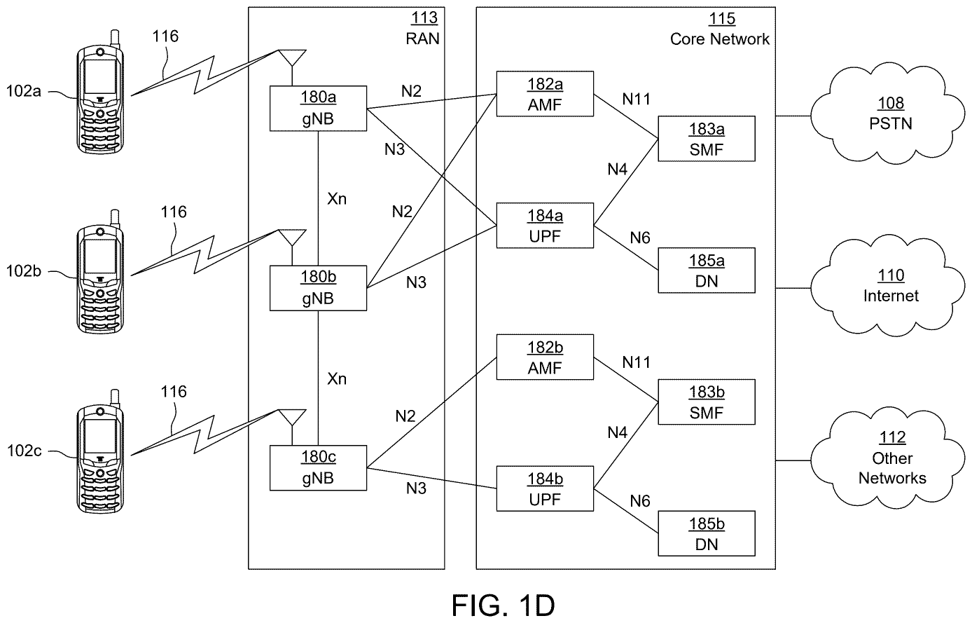

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support meter type control/machine-type communications, such as machine-type communications devices in a macro coverage area. Machine-type communications devices may have certain capabilities, for example, limited capabilities including support for (e.g., only support for) certain and/or limited bandwidths. The machine-type communications devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160csubstantially simultaneously. In the non-standalone configuration, eNode-Bs 160a, 160b, 160cmay serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following embodiments refer to the following terms.
Msg1: Msg1 is a preamble transmission. A wireless transmit/receive unit (WTRU) may select a random access preamble from a set of predefined preambles. These preambles can be of roughly two categories: Short Preamble and Long Preamble Format. The WTRU may also select a random sequence number for the preamble. After choosing the preamble and sequence number, the WTRU may transmit the preamble on a Physical Random Access Channel (PRACH).
Msg2: Msg2 is a random access response. Upon receiving Msg 1, the gNB (e.g., 5G base station) may send a response called Msg2. Msg2 may consist of several critical pieces of information, such as the Time Advance (TA) command for timing adjustment, the RAPID (Random Access Preamble ID) matching the preamble sent by the WTRU, and an initial uplink grant for the WTRU. The gNB may also assign a temporary identifier called RA-RNTI (Random Access Radio Network Temporary Identifier) to the WTRU.
Msg3: using the initial uplink grant provided in a Msg2, a WTRU may transmit Msg3 on a PUSCH (Physical Uplink Shared Channel). Msg3 is a PUSCH which may carry a certain radio resource control (RRC) message (e.g., RrcRequest) or just be pure physical data.

Msg4 (Contention Resolution): After processing Msg3, the gNB may send Msg4 to the WTRU. Msg4 is a MAC data which is for contention resolution. The contention resolution message may contain the WTRU's identity, confirming that the gNB has correctly identified the WTRU, and contention has been resolved. At this step, the network may provide WTRU with C-RNTI (Cell Radio Network Temporary Identifier)

Referring to the below various embodiments, msg3, or CB-msg3 is a non-limited example of uplink message. The below various embodiments apply also to any uplink messages from a WTRU to a base station (e.g., gNB or ng-eNB).

A basic NTN may consist of an aerial or space-borne platform which, via a gateway (GW), may transport signals from a land-based based based station (e.g., gNB) to a WTRU and vice-versa. Support for LTE-based narrow-band IoT (NB-IoT) and enhanced machine-type communication (eMTC) type devices was standardized in Rel-17, based on recommendations from 3GPP TR 36.736. Regardless of device type, it may be assumed all Rel-17 NTN WTRUs are Global Navigation Satellite System (GNSS) capable.

Aerial or space-borne platforms may be classified in terms of orbit, with Rel-17 standardization focusing on low-earth orbit (LEO) satellites with altitude range of 300-1500 km and geostationary earth orbit (GEO) satellites with altitude at 35 786 km. Other platform classifications such as medium-earth orbit (MEO) satellites with altitude range 7000-25000 km and high-altitude platform stations (HAPS) with altitude of 8-50 km may be assumed to be implicitly supported. Satellite platforms are further classified as having a “transparent” or “regenerative” payload. Transparent satellite payloads may implement frequency conversion and RF amplification in both uplink and downlink, with multiple transparent satellites possibly connected to one land-based gNB. Regenerative satellite payloads may implement either a full gNB or gNB distributed unit (DU) onboard the satellite. Regenerative payloads may perform digital processing on the signal including demodulation, decoding, re-encoding, re-modulation and/or filtering.

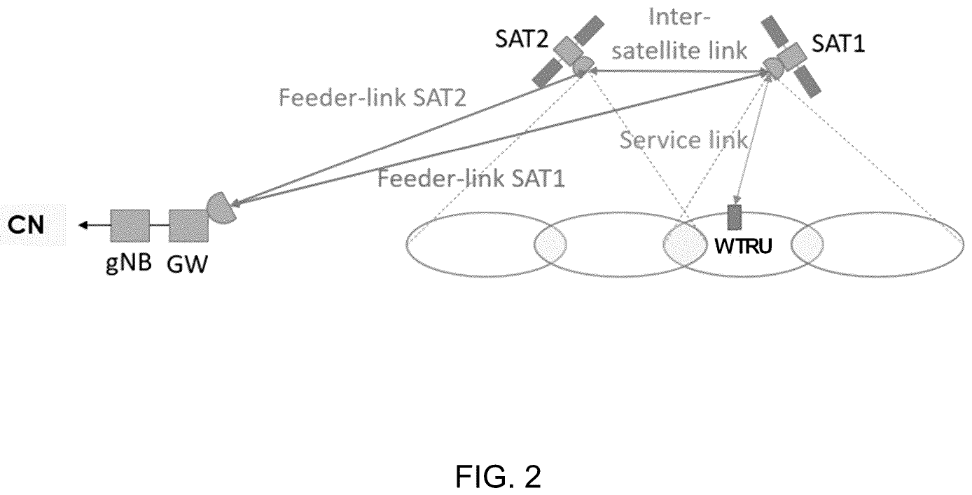

FIG. 2 depicts radio interfaces in NTN. (i) Feeder-link is a wireless link between a GW and a satellite. (ii) Service link is a radio link between the satellite and a WTRU. (iii) Inter-satellite Link (ISL) is a transport link between satellites. The ISL may be supported only by regenerative payloads and may be a 3GPP radio or proprietary optical interface.

An NTN satellite may support multiple cells, where each cell may consist of one or more satellite beams. Satellite beams may cover a footprint on earth (e.g., like a terrestrial cell) and may range in diameter from 100-1000 km in LEO deployments, and 200-3500 km diameter in GEO deployments. Beam footprints in GEO deployments may remain fixed relative to earth, and in LEO deployments, the area covered by a beam/cell may change over time due to satellite movement. This beam movement may be classified as “earth moving” where the LEO beam moves continuously across the earth, or “earth fixed” where the beam is steered to remain covering a fixed location until a new cell overtakes the coverage area in a discrete and coordinated change.

Due to the altitude of NTN platforms and beam diameter, the round-trip time (RTT) and maximum differential delay may be significantly larger than that of terrestrial systems. In a typical transparent NTN deployment, RTT may range from 25.77 ms (LEO @600 km altitude) to 541.46 ms (GEO) and maximum differential delay from 3.12 ms to 10.3 ms. The RTT of a regenerative payload may be approximately half that of a transparent payload, as a transparent configuration consists of both the service and feeder links, whereas the RTT of a regenerative payload may consider the service link only. To minimize impact to existing NR systems (e.g. to avoid preamble ambiguity or properly time reception windows), prior to initial access, a WTRU may perform timing pre-compensation.

The pre-compensation procedure may require the WTRU to obtain its position via GNSS, and the feeder-link (or common) delay and satellite position via satellite ephemeris data. The satellite ephemeris data may be periodically broadcast in system information, and may contain the satellite speed, direction, and velocity. The WTRU may estimate the distance (and thus delay) from the satellite, and then may add the feeder-link delay component to obtain the full WTRU-eNB RTT, which may be used to offset timers, reception windows, or timing relations. It may be assumed that frequency compensation may be performed by the network.

Other key enhancements in NTN may concern WTRU mobility and measurement reporting. As captured in 3GPP TR 38.821, the difference in reference signal received power (RSRP) between a cell center and a cell edge may be not as pronounced as in terrestrial systems. This, coupled with the much larger region of cell overlap, may result in traditional measurement-based mobility to become less reliable in an NTN environment. 3GPP has therefore introduced new conditional handover and measurement reporting triggers relying on location and time, for both NR and IoT-NTN. Enhanced mobility may be of special interest in LEO deployments where, due to satellite movement, even a stationary WTRU may be expected to perform mobility approximately every 7 seconds (depending on deployment characteristics).

Mobile originated early data transmission (MO-EDT) has been introduced in 3GPP Release 15 to enhance data transmission using the control plane (CP) and user plane (UP) modes, and may allow one uplink data transmission optionally followed by one downlink data transmission during the random access procedure.

MO-EDT may be triggered when the upper layers have requested the establishment or resumption of a RRC Connection for Mobile Originated data (e.g., not signaling or SMS). The uplink data size may be less than or equal to a transport block (TB) size indicated in the system information. MO-EDT may be not used for data over the control plane when using a User Plane cellular internet of thing evolved packet system (CIoT EPS)/5GS optimisations.

Several satellite operators have been promoting use of one of transmission schemes known as diversity slotted ALOHA (DSA) or contention resolution diversity slotted ALOHA CRDSA, which has been shown with various simulations to improve the performance of uplink transmission in an NTN when using EDT.

A basic idea with DSA may be to transmit multiple copies/duplicates in order that potentially colliding transmissions can be received by a network with a higher rate of success. By using simple duplicate or replica packets, the DSA scheme may have the potential to improve conventional SA throughput by about a factor of 6 at a packet error rate of 10⁻² without any modification in the demodulator.

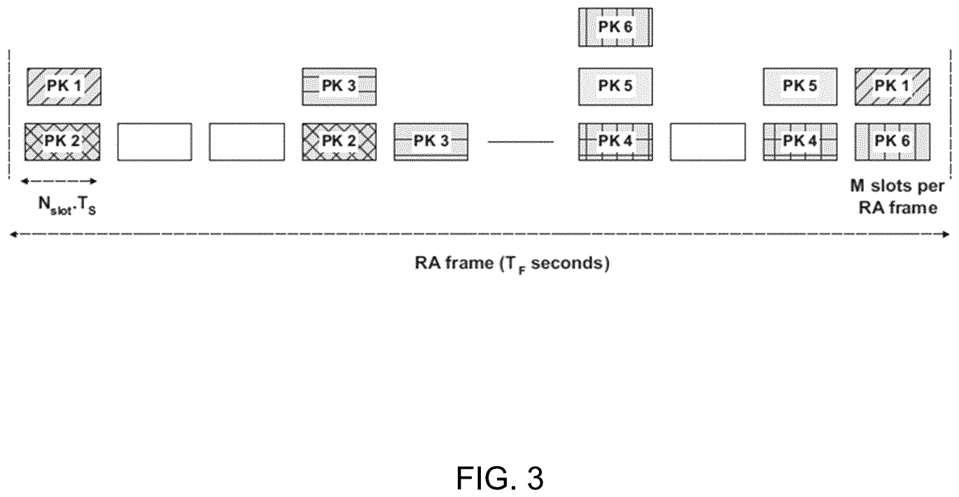

Referring to FIG. 3, an illustration of an example of packet duplication using CRDSA is shown. As can be seen, in this example illustrating CRDSA, transmissions from different WTRUs may be sent using a total of 2 duplicate packets. E.g., PK1 from WTRU1, PK2 from WTRU2, and so on. Each of the devices may select a different set of uplink resources to perform transmission, such that the probability of collision is reduced overall. For example, if a first packet collides with the transmission from another WTRU, a second packet may not. In terms of the difference between DSA and CRDSA, one (e.g., primary) difference may be the use of advanced interference cancellation with CRDSA. With DSA, the act of simply duplicating packet transmission may reduce the overall probability of collision. With CRDSA, successful decoding of one packet at the receiver, may allow for the decoded packet interference to be cancelled with other colliding transmissions. For example, in the above example, packet 3 (PK3) may be received as it does not collide with other packets. The receiver may then cancel the interference of packet 3 (PK3) with the collision between packet 2 (PK2) and packet 3 (PK3), resulting in successful decoding of packet 2 (PK2), even in the presence of a collision. While the performance of DSA has been shown to provide some improvements in system throughout and reduced collision probability, CRDSA may improve this further.

NB-IoT NTN is already being deployed. Current NB IoT NTN UL system capacity may be severely limited by the corresponding system DL capacity, due to the larger signaling overhead in the downlink (up to ˜53%), and the tight coupling between UL and DL signaling. This also impacts predominantly UL driven traffic, such as Mobile Originated (MO) transmissions, which are the primary target of massive IoT and initial emergency messaging use cases supported by IoT NTN. Therefore, in order to unlock the additional UL capacity potential, there may be a need to identify methods to decouple the UL from the DL as much as possible. Improving system capacity via reduced DL signaling and techniques such as contention-based EDT/PUR and an orthogonal cover code (OCC) may be critical to meet the capacity demands and may ensure economic viability. The 3GPP release 18 IoT NTN includes the following objective to address uplink capacity. (i) Study and specify, if beneficial the following enhancements to reduce the necessary uplink and downlink signaling to complete an early data transmission (EDT) transaction: Msg3 transmission without msg1/Random Access Response (RAR). (ii) Efficient delivery (reduced overhead) of msg4 /RRCEarlyDataComplete.

One issue related to Msg4 format may be that a contention resolution MAC CE may be used to confirm successful reception of the Msg3 at the eNB. Currently, EDT completion may be indicated using RRC. The issue may be whether the contention resolution MAC CE and the RRC message part can be transmitted separately or together. The WTRU may stop the PDCCH monitoring window(s) once it receives a contention based-msg4 (CB-msg4) containing a matching contention resolution identity. Assuming that there will be scenarios where it's possible to receive a CB-msg4 before the WTRU transmits some replicas, a WTRU may stop transmitting the remaining replicas if it has received a CB-msg4 containing a matching contention resolution identity.

Methods of completing an EDT transaction without RRC message transmission to satisfy a work item objective of “Efficient delivery (reduced overhead) of msg4/RRCEarlyDataComplete” need to be explored. In case of preconfigured uplink resource (PUR), it may be possible to terminate an EDT procedure early based on a L1 ACK or based on a time advance command (TAC) MAC CE. If a base station (e.g., (ng-) eNB) is aware that there is no pending downlink data or signaling, the (ng-)eNB may send a Layer 1 ACK optionally containing a Time Advance Adjustment to a WTRU to update the TA and terminate the procedure, or the (e.g., ng-) eNB may send a Time Advance Command to update the TA and terminate the procedure.

The WTRU may transmit an indication (L1Ack) in PURConfigurationRequest, which informs the eNB a preference for using RRCEarlyDataComplete. It may indicate RRC response message is preferred by the WTRU for acknowledging the reception of a transmission using PUR. This is an indirect way to specify that the WTRU may send some information about whether it expects downlink data (e.g. an application layer response) in response to the uplink.

In case a contention resolution MAC CE can be used to terminate uplink transmission (e.g., terminate repetitions and/or replicas), then it may need to also be known whether or not the WTRU should expect an RRC response.

A problem to be solve may be how to determine whether to release the connection and terminate EDT early without waiting for an RRC response, or whether to terminate uplink transmission only and continue to monitor PDCCH for scheduling the RRC response?

In various embodiments, a WTRU may receive a configuration for transmission on one or more uplink resources (e.g., narrowband physical uplink shared channel (NPUSCH)). This configuration may be received, for example, in response to an explicit request for resources (e.g., a PUR-Setup request or a scheduling request), based on network scheduling, or based on information broadcast in system information.

In various embodiments, a WTRU may receive a dedicated configuration enabling selection of one or more shared uplink resources. For example, the WTRU may receive an RRC reconfiguration containing the configuration for the current cell or one or more other cells, or may receive a configuration in RRC connection release.

The WTRU may additionally or alternatively receive a broadcast configuration in a system information. The broadcast configuration may include the configuration of one or more resources which may be used in the current cell (e.g., the cell on which system information may be received, and a shared uplink resource transmission may occur).

The broadcast configuration may be used in conjunction with a dedicated configuration previously received. For example, the WTRU may be configured with dedicated shared uplink resources using dedicated signaling, and contention-based shared uplink resource resources using broadcast signaling.

In various embodiments, some specific parameters may be provided in dedicated signaling, while some default parameters may be provided in broadcast signaling. If a WTRU has not received a dedicated configuration, then the WTRU should use the values provided in broadcast signaling, but if the WTRU received a dedicated configuration then the WTRU should use those values provided by dedicated signaling.

In general, any combination of parameters and configurations may be allowed by combining broadcast and dedicated signaling.

A “shared uplink resource occasion” may be defined as a set of time/frequency resources or resource blocks in which a WTRU may perform an uplink transmission. A “shared uplink resource configuration” may consist of one or more parameters to control the uplink transmission, transmission handling, or describe one or more transmission occasions. A configuration for a shared uplink resource may include, for example, one or more of the following: (i) a time or time period to transmit; (ii) frequency or frequency range to transmit, for example one of multiple narrowbands or PRBs; (iii) a number of DSA/CRDSA duplicates or replicas; (iv) one or more conditions for selection of the resources; (v) one or more resource blocks (RBs); (vi) a modulation/coding scheme (MCS) to apply during the transmission; (vii) a carrier and/or subcarrier; (viii) a narrowband physical downlink controlled channel (NPDCCH) configuration; (ix) a cyclic shift value for NPUSCH; (x) the number of repetitions for NPUSCH; (xi) the number of occasions to perform shared uplink resource transmission; (xii) a periodicity for shared uplink resource occasions and a time offset until the first shared uplink resource occasions; (xiii) a shared uplink resource response window timer; (xiv) a shared uplink resource time alignment timer value; (xv) an orthogonal cover code (OCC) configuration. For example, an (e.g., specific) OCC to use or a set of OCC configurations to select one or more from to use when performing a shared uplink resource transmission; (xvi) a cell or list of cells in which the shared uplink resource is valid; (xvii) a configuration to monitor DL early termination indication from the network. In an embodiment, the early termination indication may be resource pattern/OCC/demodulation reference signal (DMRS) specific, while in another design, the early termination indication can be valid for a group or resource patterns/OCC/DMRS. In another embodiment, there may be a single early termination indication valid for the whole configuration. The early termination indication configuration may be related to PHY layer signaling, or a higher layer signaling, e.g. MAC/RRC signaling. The early termination indication can be paging signaling.

The OCC configuration may provide one or more of the following configuration parameters: OCC length, OCC sequence index, DMRS pattern type (time domain DMRS, code domain DMRS), DMRS index, mapping or assignment of OCC index with the DMRS index, Optional linkage of DMRS pattern with the pattern used for duplicate packets. - DMRS pattern/sequence (e.g. OCC) tied with duplicate pattern.

In various embodiments, a shared uplink resources may be dedicated (e.g., reserved only for one WTRU or a set of WTRU(s)) or shared (e.g., the WTRUs may be shared among multiple WTRUs). Whether one or more shared uplink resource(s) is shared or dedicated may be explicitly indicated (e.g., within the shared uplink resource configuration), or may be implicitly determined (e.g., via the signalling method, wherein a set of shared uplink resource resources received via dedicated signalling can be assumed as dedicated, and a set of shared uplink resource resources received via broadcast signalling may be considered as shared). A dedicated set of resources may alternatively be considered as “contention free”, and a shared set of resources may be considered as “contention based”.

The WTRU may be configured to transmit a random access preamble when using a contention based shared uplink resource (for example, to transmit a random access preamble then to transmit using a shared PUSCH). In various embodiments, a set of random access may be reserved for use with contention based shared uplink resource. The random access preambles may be associated with certain shared uplink resources. A WTRU may be configured to select a random access preamble (and shared uplink resource) from a set which are configured for use when performing a contention-based shared uplink resource transmission. In various embodiments a WTRU may be configured with both dedicated and contention based shared uplink resource, and may select which to use according to one or more conditions.

In various embodiments, a shared uplink resource configuration and/or shared uplink resource transmission occasion may be associated with one or more validity conditions. If the WTRU determines that a shared uplink resource configuration or shared uplink resource occasions is “valid”, the WTRU may use the shared uplink resource for uplink transmission. Otherwise, the WTRU may not use the shared uplink resource for uplink transmissions. The WTRU may evaluate the validity of a shared uplink resource and/or shared uplink resource configuration, for example, during one or more of the following occasions: (i) prior to a transmission occasion (e.g., prior to a transmission occasion, the WTRU will evaluate the validity conditions, and will perform a transmission during the occasion if the validity condition(s) are met); (ii) periodically (e.g., the WTRU may periodically evaluate if the validity conditions are satisfied; if satisfied, the WTRU may consider all transmission occasion(s) as valid until the next validity evaluation); (iii) upon network request; (iv) upon reception and/or modification of a shared uplink resource configuration; (v) upon cell reselection.

One or more validity conditions and/or parameters to evaluate the validity conditions (e.g., thresholds, durations etc.) may be provided, for example, within the shared uplink resource configuration. A validity condition may be, for example, one or more of the following: (i) the RSRP exceeding a threshold (e.g., the WTRU may use a shared uplink resource if the RSRP exceeds a threshold); (ii) a time or time duration (e.g., the WTRU may consider a shared uplink resource configuration as valid for a specific time period); (iii) number of skipped transmission occasions (e.g., the WTRU may consider the shared uplink resource configuration as invalid if the WTRU skips a configured number of shared uplink resource occasions); (iv) the distance of a WTRU exceeding a threshold (e.g., the WTRU has travelled greater than a distance threshold from the time it received the shared uplink resource configuration); (v) the distance of the WTRU and a satellite exceed a threshold; (vi) the distance of the WTRU and a reference point exceeding a threshold; (vii) the WTRU location information becoming invalid (e.g., the GNSS location information for a WTRU has expired or has become out of date); (viii) the WTRU location information being received longer than X time ago (e.g., the WTRU received the GNSS location information greater than a time period ago); (ix) the WTRU changing cells (e.g., the WTRU performs mobility and/or cell reselection to a cell other than the cell which the provided the shared uplink resource configuration); (x) the WTRU changing to a specific cell or set of cells (e.g., the WTRU performs mobility and/or cell reselection to a specific cell and/or set of cells); (xi) the WTRU changed satellite orbits (e.g., the WTRU has transitioned from a GSO to NGSO satellite); (xii) the WTRU performs an RRC state transition (e.g., the WTRU transitions to RRC connected or RRC IDLE); (xiii) number of times a particular type of shared uplink resource has been used (for example, if contention based shared uplink resource has been used X times); (xiv) a failure condition associated with a shared uplink resource transmission (e.g., contention failure when using a contention-based shared uplink resource); (xv) a timing advance (TA) condition, for example, the WTRU may use a dedicated shared uplink resource if the UE currently has a valid TA for that cell, otherwise may use contention based shared uplink resource (and e.g. transmit a RA preamble before transmitting using NPUSCH); (xvi) whether this is a first transmission attempt, or a subsequent attempt, or using a counter (e.g. N attempts); (xvii) the cell ID belongs to one of the cell IDs (PCIs) indicated where the configuration may be valid for one or more cell IDs; (xviii) the resource belongs to a cell broadcasting a RNA where the configuration is valid for that RNA; (xix) the resource belongs to a cell broadcasting a TAC (or PLMN) where the configuration is valid for that TAC (or PLMN).

If the WTRU determines that a shared uplink resource is not valid (e.g., one or more validity criteria is not satisfied), the WTRU may perform one or more of the following actions: (i) skip one or more UL transmission occasion(s) (i.e., not transmit on the uplink resources); (ii) release the shared uplink resource configuration; (iii) send an indication to the network; (iv) apply an alternative shared uplink resource configuration (e.g., the WTRU may switch from a dedicated shared uplink resource configuration to a shared configuration); (v) select a new coverage level (e.g., next/lower coverage level); (vi) perform RACH-based EDT.

A WTRU may receive additional assistance information to evaluate the validity of a shared uplink resource configuration and or resource. Examples of assistance information may include, for example, one or more of the following: (i) a reference point; (ii) satellite ephemeris data (e.g., satellite location, direction, speed, and/or orbital parameters); (iii) epoch time of satellite assistance information; (iv) satellite footprint information, such as radius of cell footprint; (v) WTRU location information (e.g., GNSS information)

The assistance information may be related to the current serving cell, one or more neighboring cells, and/or one or more neighboring satellites. The assistance information may be received as part of the shared uplink resource configuration, or separately (e.g., via RRC signaling, MAC CE, downlink control information (DCI), PDSCH, PDCCH, system information, or non-access stratum (NAS) signaling).

The WTRU may receive a shared uplink resource configuration, indication of shared uplink resources, or assistance information to determine the validity of a shared uplink resource configuration and/or shared uplink resource occasion via broadcast signaling (e.g., via system information) and/or via dedicated signaling (e.g., via RRC signaling, MAC CE, DCI, PDSCH, PDCCH, or NAS signaling).

The WTRU may receive one or more aspects of a shared uplink resource configuration via different signaling methods. For example, the WTRU may receive one set of parameters of a shared uplink resource configuration via dedicated signaling, and a second set via broadcast signaling. If a parameter is provided by both dedicated and broadcast signaling, the WTRU may select which value to apply, for example, based on one or more of the following rules: (i) the WTRU may (e.g., always) apply the value received via dedicated signaling; (ii) the WTRYU may (e.g., always) apply the most recent value; (iii) the WTRU may select a value based on WTRU implementation; (iv) the WTRU may select a value based on the data to be transmitted; (v) the WTRU may select a value based on any of the criteria which may be used for shared uplink resource selection.

A coverage level may be determined using a criteria corresponding to the downlink signal quality, e.g. RSRP threshold. For example, a WTRU may be configured with coverage levels CE level 0, CE level 1, CE level 2. The WTRU may determine it is using CE level 0 if the measured DL RSRP is above a first threshold. If the DL RSRP is not above the first threshold then the WTRU may determine it is using CE level 1 if the DL RSRP is above a second threshold. If the DL RSRP is not above the first or the second threshold then the WTRU may determine it is using CE level 2.

The WTRU may receive a configuration corresponding to one or more coverage levels. The configuration may include, for each of the configured coverage levels, any of the following information: (i) the WTRU may receive an indication of the number of PUSCH repetitions to use for that coverage level; (ii) the WTRU may receive an indication that RACH-less transmission is enabled (so WTRU may transmit using the PUSCH resources without transmitting RACH) or disable (so WTRU may have to transmit random access preambles and may not transmit using PUSCH until a RAR with a scheduling grant is received); (iii) the WTRU may receive an indication of whether DSA or CRDSA is enabled for this coverage level; (iv) the WTRU may receive an indication of the number of replicas to transmit for this coverage level; (v) the WTRU may receive an indication of how to assign repetition number for each duplicate (e.g., a different number of repetitions may be received for each duplicated); (vi) the WTRU may receive an indication of a narrowband (e.g., frequency location) determination parameter; (vii) the WTRU may receive an indication of a resource block or resource allocation determination parameter; (viii) time between duplicates (e.g., the WTRU may select a random number or number based on WTRU-ID, to determine which narrowband, RB, timing, to use for each replica); (ix) the WTRU may receive additional parameters for determining any of the above based on a second condition; (x) the WTRU may receive OCC parameters based upon which the WTRU may determine the suitable OCC and/or DMRS for each repetition and duplicate transmission. The OCC configuration may provide one or more of the following configuration parameters: (a) OCC length; (b) OCC sequence index; (c) DMRS pattern type (time domain DMRS, code domain DMRS); (d) DMRS index; (e) mapping or assignment of OCC index with the DMRS index; (f) optional linkage of DMRS pattern with the pattern used for duplicate packets. - DMRS pattern/sequence (e.g., OCC) tied with duplicate pattern.

In various embodiments, information may be provided from the device application layer (e.g., operating system or specific application on a device) to the radio access protocol (e.g., device chipset) regarding the traffic pattern or type of traffic expected. The application layer information may be device specific, application specific, or specific to an individual data exchange. As such, the indication may be provided once (E.g. when the device is powered on), or at the start of a session (e.g., a reporting session starts, and multiple transmissions are expected in the session), or at the beginning of every uplink transmission.

Information provided by the application/upper layers may include one or more of the following: (i) transmission data amount (e.g., transport block size, SDU/PDU size, amount of bit or bytes of information); (ii) data priority (e.g., whether the information is critical); (iii) data periodicity (e.g., how frequently data is expected to be transmitted, every X seconds); (iv) number of occurrences (e.g., how many times data is expected within a certain time period, absolute number of occurrences); (v) response type, for examples: (a) whether an application layer response is expected from the network; (b) whether an RRC response is preferred from the network; (iii) how frequently an application layer response is expected (e.g., once every X transmissions); (iv) when a response is expected (e.g. immediately, within seconds, hours, etc); (v) how much data is expected in the response (e.g. see transmission data amount).

The WTRU may indicate to the (e.g., ng-) eNB that it may be interested in being configured with a contention based-Msg3 (CB-Msg3) by sending request message providing information about the requested resource (e.g., No. of occurrences, periodicity, time offset, TBS, RRC Ack, etc.). In various embodiments, the WTRU may additionally provide application layer information to the network (e.g., whether application layer is expected to response, etc). The information may be conveyed in an RRC message (for example, PURConfigurationRequest) when requesting a CB-Msg3.

Information may be conveyed in an RRC message upon initiating an uplink data transmission including uplink user data which may be transmitted using a CB-Msg3 resource in a NAS message concatenated in RRCEarlyDataRequest message on a Common control channel (CCCH).

In various embodiments, the information may be provided using one or more of the following methods: (i) a RRC message; (ii) a NAS message (for example, REGISTRATION REQUEST, TRACKING AREA UPDATE REQUEST, etc); (iii) implicitly by selecting a specific RACH preamble or a preamble from a specific group of preambles; (iv) implicitly by selecting a specific CB-Msg3 resource (e.g., NPUSCH resources) or a resource from a specific group of CB-Msg3 resources; (v) in a MAC CE; (vi) in uplink control information (E.g. NPUCCH)

In various embodiments, the network may detect whether a problem has occurred due to contention (all of a particular WTRU replicas collided) or due to coverage (not enough repetitions to decode). In this instance, the WTRU may receive an explicit indication, for example as part of or instead of an acknowledgement or contention resolution MAC CE, which informs the WTRU whether to update (e.g. increase) the number of repetitions, to update (e.g. increase) the number of replicas, to update (e.g. change) the resource pattern used, or to select a configuration corresponding to a particular index or coverage level.

A WTRU may be configured to receive an indication from the network (e.g., a L1 ACK on PDCCH, a MAC CE, or an RRC message). The WTRU may be configured to receive an indication for an early termination of UL transmission over the shared resource. The WTRU may be configured to detect and monitor early termination as part of the configuration for shared UL resource.

The WTRU may be configured to receive an early termination indication when it is transmitting in the UL direction in a contention-based resource. The WTRU may receive the early termination indication from the network as PHY signaling, or higher layer signaling. The early termination indication may be transmitted by the network in a broadcast manner or groupcast manner. The early termination indication may provide an indication of a specific resource, or it may be transmitted by the network in relation to all contention-based EDT resources.

Upon receiving early termination indication, the WTRU may determine if this is relevant for WTRU transmission. The WTRU may determine the indication to be relevant for its UL transmission if the WTRU is transmitting in the UL direction and it receives an early termination indication, where the indication may be related to the WTRU resource pattern or the indication may be related to all the resources. In an alternative embodiment, the early termination indication may be associated to the WTRU identity, e.g., a random identity used by the WTRU during EDT, WTRU IMSI, T-IMSI, a suitable Radio Network Temporary Identifier (RNTI) associated to the WTRU's transmissions, etc.

The WTRU may receive early termination indication from the network for any one or more of the following:
(i) ACK from the network: in an embodiment, the WTRU may receive early termination indication from the network based upon network successfully decoding WTRU data. As an example, the WTRU may have selected a pattern with several duplicate transmissions and the network is able to decode the data. The network may then transmit an ACK to save the WTRU from subsequent transmissions over the determined/indicated resource pattern.
(ii) Resource pattern overloading: in an embodiment, the WTRU may receive early termination indication from the network where the network detects multiple WTRUs transmitting over the same resource/pattern, and the network provides early indication, so that the WTRU may select a different resource. With this type of the indication, the network may indicate a back-off time, an alternative pattern, an alternative OCC, etc to use.
(iii) OCC and/or DMRS code overloading: in an embodiment, several WTRUs may select the same OCC index (and/or DMRS index) in relation to their UL transmissions over the shared resource. As overloading, the OCC code (and/or DMRS code) may lead to very high interference levels, the network may provide an early termination indication, which instructs the WTRUs using a specific resource/pattern to abort their transmissions.

A WTRU may receive an indication of early termination from the network. The WTRU may determine if the early termination indication is an ACK for successful reception or pertains to any of the failure cases (e.g., resource pattern overloading, OCC overloading, DMRS overloading etc).

If the WTRU determines that the early indication is an ACK for the successful reception of WTRU data, the WTRU may determine the reception of early termination indication as completion of EDT transaction and/or RRC connection release message.

If the WTRU determines that the early indication is related to any of the failure cases (e.g., resource pattern overloading, OCC overloading, DMRS overloading etc), based upon the WTRU determining the failure of its UL transmission and the additional information received as part of the early termination indication, the WTRU may perform any one or more of the following: (i) re-select the EDT resource and re-transmit; (ii) back off for a configured/indicated time and retransmit; (iii) fall back to a different CE level; (iv) fall back to a RACH preamble based transmission over the same/different CE level; (v) re-transmit over a CE level or resource pattern and/or OCC/DMRS where the WTRU receive an indication of CE level/pattern/OCC/DMRS as part of the early termination indication; (vi) increase or decrease the number of repetitions; (vii) Increase or decrease the number of replicas; (vii) increase or decrease the transmission power

A WTRU may receive downlink early termination indication, for example in a contention resolution MAC CE. The WTRU may receive the information, e.g., first information, about how to interpret the early termination indication. The WTRU may receive/derive the first information based upon the CB-EDT configuration, and/or based upon the received system information, and/or based upon the (prior) configuration received from the network, and/or based upon the specification.

The WTRU may determine, based upon the first information, whether there will be any explicit or implicit indication in the early termination indication associated to the RRC completion of the EDT transaction. The WTRU determination of RRC completion indication may be based upon the received first information. The first information may indicate to the WTRU with one or more of the following behaviors: (i) The WTRU may consider the reception of early termination indication as completion of EDT transaction and may not wait for DL RRC response message; (ii) the WTRU may expect to receive DL RRC response message after the reception of early termination indication; (iii) the WTRU may determine to end the EDT transaction or expect to receive explicit RRC response message based upon an explicit/implicit indication in the early termination message.

As part of the downlink early termination indication, for example in a contention resolution MAC CE, the WTRU may receive an indication to notify the WTRU whether to consider the EDT transaction as complete or whether to wait for a downlink RRC response message (e.g., RRCEarlyDataComplete, containing a NAS message).

If the WTRU determines, based on the indication, that the entire EDT procedure may terminate early, the WTRU may stop transmitting any pending Msg3 repetitions or replicas. The WTRU may release the RRC connection. The WTRU may go to RRC_IDLE mode.

If the WTRU determines, based on the indication, that the entire EDT procedure cannot terminate early, the WTRU may interpret the indication as an acknowledgement that Msg3 has been successfully received by the eNB, and as such terminates any pending Msg3 repetitions and replicas. However, the WTRU may continue to monitor PDCCH in order that it can receive a downlink RRC response that may contain a NAS message (e.g., the application layer data).

The indication may include further information to the WTRU. For example, the indication may include any of the following: (i) the indication may include a (e.g., specific) RNTI to monitor on PDCCH to receive the RRC response message; (ii) the indication may include a specific search space indication or configuration where the WTRU will expect to receive the RRC response message; (iii) the indication may include a CORESET indication or configuration where the WTRU will expect to receive the RRC response message; (iv) the indication may include a different anchor carrier or bandwidth part where the WTRU will expect to receive the RRC response message; (v) the indication may schedule a PDSCH resource on which to receive the RRC response, at a later time; (vi) the indication may include an explicit or implicit (e.g. configured earlier in system information, or specified in the standard) timer or counter or countdown. Upon expiry, the WTRU may consider the procedure as failed and/or no downlink response will be received. The WTRU may release the RRC connection. The WTRU may enter idle mode after releasing the RRC connection; (vii) the indication may include a delay after which the WTRU will start monitoring PDCCH for the scheduling of downlink RRC response. This may enable to WTRU to save some power by not having to monitor PDCCH for the duration of this delay; (viii) the indication may include a time or location based condition. As a first example, if the WTRU location is within a threshold distance from a reference location, then the WTRU may monitor PDCCH for the downlink RRC response, and otherwise release the connection and return to idle mode. As a second example, the WTRU may wait for a downlink response until a certain time (e.g., t-Service) and then release the connection. As a third example, when the absolute time measured at the WTRU is within a time window (e.g. between T1 and T2).

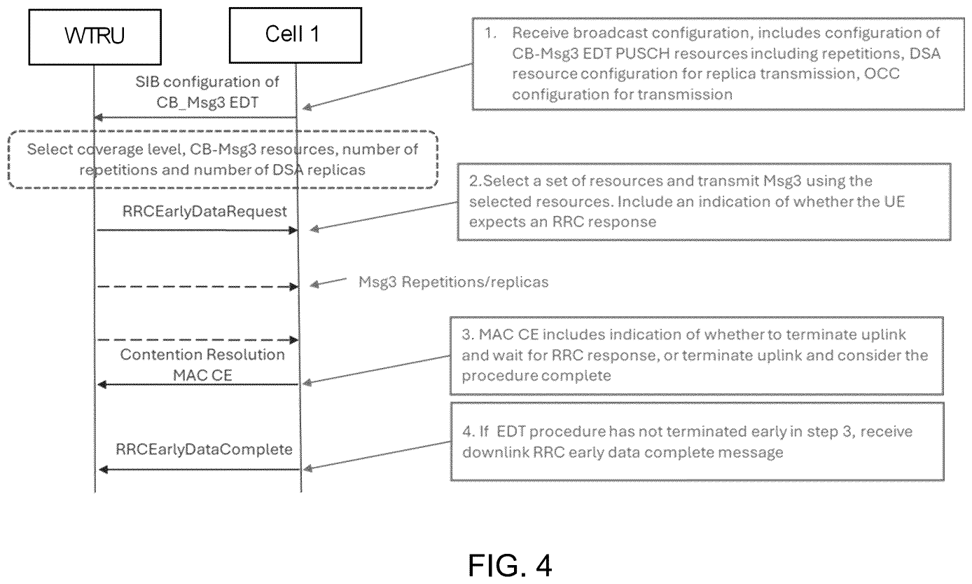

Referring to FIG. 4, a method to terminate uplink transmission, from example uplink Msg3 transmission, and to determine whether to terminate the EDT procedure early or to monitor PDCCH for RRC termination and downlink application layer response, is shown.

At a first step, a WTRU may receive from a base station (e.g., cell1 or gNB or ng-eNB), a broadcast configuration (e.g., System Information Blocks configuration) that may comprise configuration information including configuration of uplink message resources. More particularly, the configuration of uplink message resources may be a configuration of CB EDT PUSCH resources, or CB-Msg3 EDT PUSCH resources. The configuration of uplink message resources may further include repetitions. In addition, the broadcast configuration may comprise resources configuration for allocation of slots for data packet replicas transmission (e.g., DSA resources configuration for replica transmission). The broadcast configuration may further include coding configuration for transmission. The coding configuration for transmission may comprise OCC configuration for transmission.

At a second step, the WTRU may select a set of resources and transmit the uplink message (e.g., Msg3) using the selected resources. More particularly, the WTRU may select any of a coverage level, CB-Msg3 resources, a number of repetitions and a number of (e.g., DSA) replicas. The uplink message may comprise information indicating whether the WTRU expects a RRC response (e.g., RRCEarlyDataRequest).

At a third step, the WTRU may receive downlink indication (e.g., contention resolution MAC CE). In an embodiment, upon transmission of one or more of the (e.g., DSA) replicas, the WTRU may monitor for the indication from downlink message (e.g., PDCCH).

Based on the indication (e.g., MAC CE field, or in a DCI that may schedule the MAC CE) in the contention resolution (e.g., MAC CE), the WTRU may terminate uplink (e.g., Msg3) transmission (e.g., more replicas and/or repetition). More particularly, the indication may indicate successful reception at the base station (eNB, or gNB) or may indicate a negative acknowledgement (NACK) with action to be taken (e.g., back-off, retry, continue, select new set of resources, etc.)

Based on the indication (e.g., MAC CE field, or in a DCI that may schedule the MAC CE) in the contention resolution (e.g., MAC CE), the WTRU may determine whether to either (i) consider the EDT transaction/procedure as complete, such the WTRU may return to RRC_IDLE (early EDT termination), or (ii) continue to monitor (e.g., PDCCH) for DL scheduling of RRC response. The WTRU may release the RRC connection. The WTRU may determine to continue to monitor for DL scheduling of RRC response when the indication may include any of a RNTI to monitor, a PDSCH resource indication, a timer after which the procedure fails if no response, and a delay before monitoring PDCCH.

At step 4, based on a determination that the EDT procedure has not terminated early, the WTRU may receive a downlink RRC early data complete message.

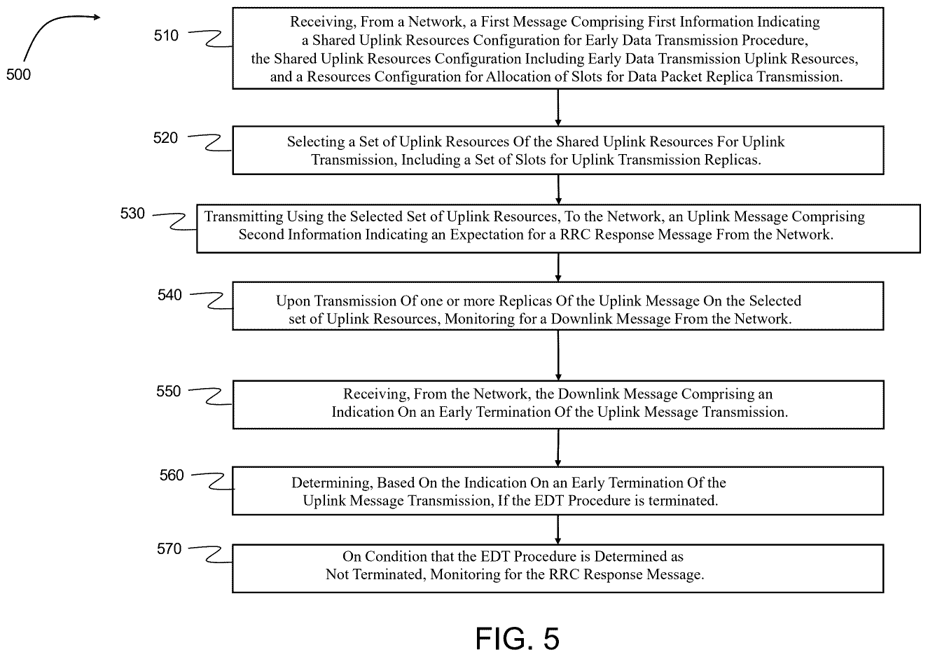

Referring to FIG. 5, an example of a method 500 to terminate uplink message transmission and determine whether to terminate an EDT procedure early or monitor PDCCH for RRC termination is shown. The method 500 may comprise a step wherein a WTRU may be configured to receive 510, from a network, a first message comprising first information indicating a shared uplink resources configuration for early data transmission procedure, the shared uplink resources configuration including early data transmission uplink resources, and a resources configuration for allocation of slots for data packet replica transmission. The resources configuration for allocation of slots for data packet replica transmission may include a diversity slotted ALOHA (DSA) or contention resolution DSA (CRDSA) resources configuration for replica transmission. The method 500, may comprise a step wherein the WTRU may be configured to select 520 a set of uplink resources of the shared uplink resources for uplink transmission, including a set of slots for uplink transmission replicas. The method 500 may comprise step wherein the WTRU may transmit 530 , using the selected set of uplink resources, to the network, an uplink message comprising second information indicating an expectation for a radio resource control (RRC) response message from the network. The uplink message may be a contention based Msg3 message transmitted on a physical uplink shared channel (PUSCH). Upon transmission, from the WTRU, of one or more replicas of the uplink message on the selected set of uplink resources, the method 500 may comprise a step wherein the WTRU may monitor 540 for a downlink message from the network. The downlink message may be a physical downlink control channel (PDCCH) transmission from the network. The method 500 may comprise a step wherein the WTRU may receive 550, from the network, the downlink message comprising an indication on an early termination of the uplink message transmission. The method 500, may comprise a step wherein the WTRU may determine 560, based on the indication on an early termination of the uplink message transmission, if the early data transmission procedure is terminated. And, on condition that the early data transmission procedure is determined as not terminated, the method 500 may comprise a step wherein the WTRU may monitor 570 for the RRC response message. On contrary, on condition that the early data procedure is determined as terminated, the method 500 may comprise a step wherein the WTRU may stop monitoring for the downlink message from the network, and may remain in RRC_idle mode.

Following the step of receiving the indication on the early termination of the uplink message transmission, the method 500, may comprise a step wherein the WTRU may be configured to stop uplink message transmissions.

The WTRU may be able to determine that the early data transmission procedure is not terminated based on the indication that may include any of a radio network temporary identifier (RNTI) to monitor for the downlink message to receive the RRC response message, a PDSCH resource on which to receive the RRC response, a delay before monitoring the downlink message, and a counter value after which the WTRU release RRC connection.

The shared uplink resources (e.g., broadcasted uplink resources) configuration may comprise a coding configuration for the uplink transmission, and wherein the uplink message and the one or more replicas of the uplink message are transmitted using the coding configuration. The coding configuration may include orthogonal cover code configuration.

The indication on an early termination of the uplink message transmission may be a MAC CE field in a contention resolution MAC CE, or the indication on an early termination of the uplink message transmission may be included in a downlink control information scheduling a MAC CE in a contention resolution MAC CE.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method, implemented in a wireless transmit/receive unit (WTRU), comprising:
receiving, from a network, a first message comprising first information indicating a shared uplink resources configuration for early data transmission procedure, the shared uplink resources configuration including early data transmission uplink resources, and a resources configuration for allocation of slots for data packet replica transmission;
selecting a set of uplink resources of the shared uplink resources for uplink transmission, including a set of slots for uplink transmission replicas;
transmitting using the selected set of uplink resources, to the network, an uplink message comprising second information indicating an expectation for a radio resource control (RRC) response message from the network;
upon transmission of one or more replicas of the uplink message on the selected set of uplink resources, monitoring for a downlink message from the network;
receiving, from the network, the downlink message comprising an indication on an early termination of the uplink message transmission;
determining, based on the indication on an early termination of the uplink message transmission, if the early data transmission procedure is terminated; and
on condition that the early data transmission procedure is determined as not terminated, monitoring for the RRC response message.

2. The method of claim 1, further comprising: following the receiving of the indication on the early termination of the uplink message transmission, stopping uplink message transmissions.

3. The method of claim 1, further comprising: on condition that the early data procedure is determined as terminated, stopping monitoring for the downlink message from the network, and remaining in RRC_idle mode.

4. The method of claim 1, wherein the determining that the early data transmission procedure is not terminated is based on the indication including any of a radio network temporary identifier (RNTI) to monitor for the downlink message to receive the RRC response message, a PDSCH resource on which to receive the RRC response, a delay before monitoring the downlink message, and a counter value after which the WTRU release RRC connection.

5. The method of claim 1, wherein the downlink message is a physical downlink control channel (PDCCH) transmission from the network.

6. The method of claim 1, wherein the uplink message is a contention based Msg3 message transmitted on a physical uplink shared channel (PUSCH).

7. The method of claim 1, wherein the resources configuration for allocation of slots for data packet replica transmission include a diversity slotted ALOHA (DSA) or contention resolution DSA (CRDSA) resources configuration for replica transmission.

8. The method of claim 1, wherein the shared uplink resources configuration further comprises a coding configuration for the uplink transmission, and wherein the uplink message and the one or more replicas of the uplink message are transmitted using the coding configuration.

9. The method of claim 1, wherein the indication on an early termination of the uplink message transmission is a MAC CE field in a contention resolution MAC CE.

10. The method of claim 1, wherein the indication on an early termination of the uplink message transmission is included in a downlink control information scheduling a MAC CE in a contention resolution MAC CE.

11. A wireless transmit/receive unit (WTRU) comprising a processor, a transceiver and a memory, which are configured to:
receive, from a network, a first message comprising first information indicating a shared uplink resources configuration for early data transmission procedure, the shared uplink resources configuration including early data transmission uplink resources, and a resources configuration for allocation of slots for data packet replica transmission;
select a set of uplink resources of the shared uplink resources for uplink transmission including a set of slots for uplink transmission replicas;
transmit using the selected set of uplink resources, to the network, an uplink message comprising second information indicating an expectation for a radio resource control (RRC) response message from the network;
monitor for a downlink message from the network, upon transmission of one or more replicas of the uplink message on the selected set of uplink resources;
receive, from the network, the downlink message comprising an indication on an early termination of the uplink message transmission;
determine, based on the indication on an early termination of the uplink message transmission, if the early data transmission procedure is terminated; and
monitor for the RRC response message, on condition that the early data transmission procedure is determined as not terminated.

12. The WTRU of claim 11, wherein the transceiver, the memory, and the processor are configured to: following reception of the indication on the early termination of the uplink message transmission, stop uplink message transmissions.

13. The WTRU of claim 11, wherein the transceiver, the memory, and the processor are configured to:
stop monitoring for the downlink message from the network, and remain in RRC_idle mode, on condition that the early data procedure is determined as terminated.

14. The WTRU of claim 11, wherein the transceiver, the memory, and the processor are configured to determine that the early data transmission procedure is not terminated, based on the indication including any of a radio network temporary identifier (RNTI) to monitor for the downlink message to receive the RRC response message, a PDSCH resource on which to receive the RRC response, a delay before monitoring the downlink message, and a counter value after which the WTRU release RRC connection.

15. The WTRU of claim 11, wherein the downlink message is a physical downlink control channel (PDCCH) transmission from the network.

16. The WTRU of claim 11, wherein the uplink message is a contention based Msg3 message transmitted on a physical uplink shared channel (PUSCH).

17. The WTRU of claim 11, wherein the resources configuration for allocation of slots for data packet replica transmission include a diversity slotted ALOHA (DSA) or contention resolution DSA (CRDSA) resources configuration for replica transmission.

18. The WTRU of claim 11, wherein the shared uplink resources configuration further comprises a coding configuration for the uplink transmission, and wherein the uplink message and the one or more replicas of the uplink message are transmitted using the coding configuration.

19. The WTRU of claim 11, wherein the indication on an early termination of the uplink message transmission is a MAC CE field in a contention resolution MAC CE.

20. The WTRU of claim 11, wherein the indication on an early termination of the uplink message transmission is included in a downlink control information scheduling a MAC CE in a contention resolution MAC CE.
